(19) United States
(12) Patent Application Publication
(10) Pub. No.: US 2005/0244799 A1
(43) Pub. Date: Nov. 3, 2005

(54) Device, method and program for performance tracking and improvement

(76) Inventor: Peter John Skenandore, Fall City, WA (US)

Correspondence Address: THORPE NORTH & WESTERN, LLP., 8180 SOUTH 700 EAST, SUITE 200, P.O. BOX 1219, SANDY, UT, 84070, US

(21) Appl. No.: 10/835,780

(22) Filed: Apr. 29, 2004

(51) Int. Cl. G09B 19/00

(52) U.S. Cl. 434/238

(57) ABSTRACT

A device and method are provided for educating and creating progressive incentives for an individual. The device includes a durable card configured to be carried by an end user. A performance chart can be located on the performance device. A plurality of performance event recording areas can be included in the performance chart. The performance event recording areas are also configured to correspond to the time period, frequency, and quality of performance events performed by an end user in a performance commitment made by the end user.

This non-provisional application claims priority to U.S. application No. 60/466,627 filed Apr. 29, 2003.

### FIELD OF THE INVENTION

The present invention relates generally to education, performance tracking, incentives and performance improvement.

### BACKGROUND

There is a growing cultural phenomenon caused by modern media. Very sophisticated marketing techniques are used to associate a products use with glamour, fame, money, and quick results. As a result, consumers have been more and more drawn to purchase products and services that increasingly do not deliver the results portrayed with these very sophisticated marketing techniques. This constant bombardment of advertisements has reinforced the growing mentality that good health and “get rich quick” results can be purchased in a pill, drink, article of clothing or even the latest exercise machine gimmickry.

If asked, most people would generally agree with the idea that they would like to improve their personal performance in some particular aspect of their life. However, our society has become increasingly susceptible to purchasing ineffective products and services. An example is health improvement, where our nation's spending has increased dramatically in tandem with the increase of our nation's rate of obesity, diabetes, and heart disease. Instead of searching for the next craze, fad, or bandwagon, individuals need to seek out knowledge that can be more readily applied to their lives. In other words, individuals need knowledge that reinforces and supports positive health and self improvement behavior.

Many people do realize that persistence and practice can provide results in areas where education, knowledge, and performance improvement is desired. However, even if individuals do realize the importance of persistence and practice, they may still have difficulty implementing these principles. Persistence in a given area must generally be sustained for a lengthy period of time in order to reap the benefits of the desired performance increase. For example, if an individual desires the educational benefits of studying music, a sustained program of musical practice and study of music theory will generally result in improved musical knowledge and skill. Even though most people are aware of the benefits of persistent practice and study, it can be difficult to develop and stick to a musical practice regiment for longer than just a few, days, weeks, or months at a time.

Incentive is also another issue surrounding improving personal performance. An individual may desire to increase their performance in a specific educational area or skill, but after a period of time may abandon their efforts. Because performance improvement requires a supportive amount of work and repeated effort to alter behaviors that are predisposed, performance improvement can be a difficult process. When a performance improvement process is undertaken by an individual alone, then it can be difficult to maintain that motivation.

Keeping focus on educational and self improvement goals that an individual has set for themselves can also be a problem for many people. This is because people can be easily distracted when other fun, alluring, or easier activities are presented to them that do not contribute to their intended goal(s). As a result, it is valuable to have outside support and other reward systems to aid individuals in attaining measurable performance results. These outside support materials can be designed in such a way that they are fun, exciting, and visually stimulating educational and performance measuring materials. Stimulating performance improvement materials help the individual avoid being pulled away by other distractions as easily.

Another example of the value of improving an individual's performance using education and applied effort is in the area of health improvement. If an individual's health has been ruined over a long period of time or many years, then this problem cannot be solved in just a week or a month. The individual needs to be educated in a way that they can take charge of their own health. Such an educational perspective about health can help the individual be aware of the choices they can make to increase their overall health and well-being. This increased knowledge helps the individual channel their choices and effort and a better way. While this sounds straightforward on a theoretical level, actually implementing this process in a concrete way can be a difficult task for an individual.

### SUMMARY OF THE INVENTION

The invention provides a device and method for performance tracking and improvement. The device includes a durable card, or cards and supportive educational materials, progressive programs, and incentives configured to be carried and accessed by an end user. A performance chart can be located on the performance device. A plurality of performance event recording areas can be included in the performance chart. The performance event recording areas are also configured to correspond to the time period, frequency, and quality of progress events performed by an end user in a performance commitment made by the end user.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1A illustrates the front side performance tracking card in an embodiment of the invention with the approximate thickness and size of a standard credit card;

FIG. 1B illustrates the reverse side of the card displayed in FIG. 1A;

FIGS. 2A and 2B illustrates an embodiment of the invention where information would be displayed horizontally or lengthwise on the card;

FIG. 3A illustrates an embodiment wherein some examples of the shape of the card could be a convex shape;

FIG. 3B illustrates an embodiment wherein some examples of the shape of the card could be a profile or abstract shape;

FIG. 3C illustrates an embodiment wherein some examples of the shape of the card could be concave shape;

FIG. 3D illustrates an embodiment wherein some examples of the shape of the card could be an oversized card;

FIG. 4 illustrates a method for designing performance cards in accordance with the present invention;

FIGS. 5A and 5B illustrate the front and reverse sides of a performance card for tracking water consumption in an embodiment of the invention;

FIGS. 6A and 6B illustrate the front and reverse sides of a performance card for tracking cardio workouts to increase stamina in an embodiment of the invention;

FIGS. 7A and 7B illustrate the front and reverse sides of a performance card for tracking music practice in an embodiment of the invention;

FIG. 8 illustrates the use of a performance chart or card within a personal digital assistant in an embodiment of the invention;

FIG. 9 illustrates the use of a performance chart or card within a personal computer in an embodiment of the invention;

FIG. 10 illustrates a method for marketing the performance devices of the present invention;

FIG. 11 illustrates a brochure in which pouches can be formed to hold performance cards and folded; and

FIG. 12 illustrates an embodiment of keycards used as awards for accomplishments and completion of performance charts.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention involves providing a structural and organizational framework for delivering performance enhancement products, programs, education, and incentives. Particularly, these performance enhancement devices and methods are designed to promote self awareness and behavior tracking. In addition, this performance enhancement invention is a framework for helping individuals create and embed behavior changes in their lives. In this way, individuals can learn responsibility for and eventually own their personal behavior and reap the beneficial results of channeling their behavior in productive paths.

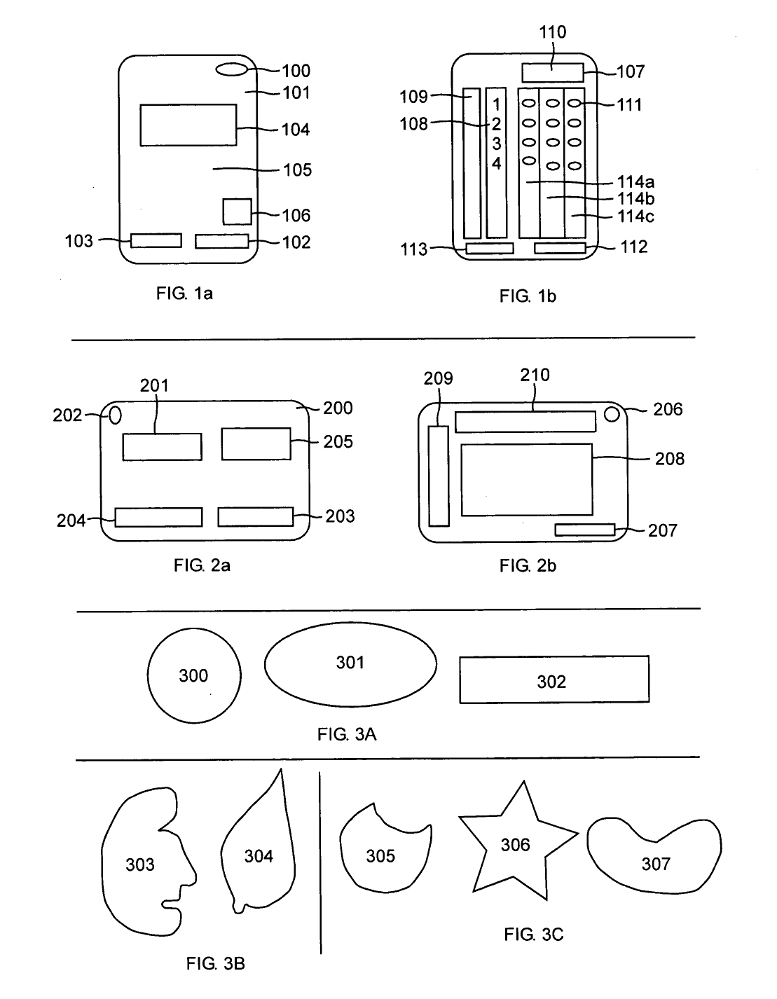

In order to understand the present invention more fully a physical component of the invention will now be described. However, it should be understood that the physical components described herein are part of a larger method for performance and achievement programs. FIG. 1A illustrates the front side of a paper, plastic, or PVC (polyvinylchloride) card with the approximate thickness and size of a credit card or otherwise sized to fit in an individuals pocket, wallet, or purse. The corners may be squared off or slightly rounded. In this embodiment, information and graphics on the front and back of card (FIG. 1A, 1B) can be displayed vertically. The card may include an aperture 100 die cut into the card to enable fastening systems to connect the card, or cards to a lanyard, belt clip, or bracelet. The aperture enables the card user to collect a number of the cards over time as achievement levels of the performance program are worked on. A background graphic 100 can be printed onto the card along with a company logo, copyright, patent pending, or other business info 102. Company info 103 can be printed on the card. In addition, the current performance program or title can be printed onto the card. The basic card color 105 can be any selected color or texture applied to the card. While the contents of the card are important, what is just as important is how the cards are used within a performance program that will be described later.

The card may also contain a location where the participants' advancement recognition 106 is applied in the form of a sticker, stamp, decorations, ornaments, appliqué or brand. These stickers may also be graded based on the level of advancement achieved. For example, improvements in the area of art can be awarded graded colors, or an artistic implement. Achievements in music can be awarded sheet music, notes, chords, or even measures of music to be played or written in a game. Achievement in writing or story telling can be awarded writing characters, writing themes, and base stories on which a story can be expanded, written, etc. These awards may also enter participants into contests. In other words, the awards presented can signify talents, attributes, or even elements in game play between end users of the cards. Advancement recognition will be discussed in further detail later.

In addition to the individual indicia, stickers or stamps, the present invention can incorporate performance cards and devices where multiple placement areas or values are fulfilled with indicia signifying movement up or through a specific program or group of different programs. For example, Jane may starts a cardio program and receive a membership card. She completes phase I of the program and receives a sticker over a predefined location on her membership card. Then she starts the 2^{nd} phase of the program and completes that phase. She then receives a 2^{nd} sticker in a pre-defined location on the card signifying her completion of phase 2, and so on. This method can apply to the many educational disciplines and applications of the present invention discussed in the present description.

In addition to simply using the performance indicia for a specific discipline area, the performance indicia on a single card can cover a plurality of disciplines. For example, a card may include music, diet and art. Thus, the individual using the program would put indicia on the card as they progressed through each of the levels or segments of the educational and performance programs. This juxtaposition of separate programs allows the end user to compare their progress in various programs. The card groups can also include master cards which represent levels of performance and achievement all of the areas of discipline provided in the present invention. For example, a master card can include performance ranking indicia for areas like physical health, mental conditioning, science, arts, inter-personal relationships and other areas of discipline. Thus, the end user can increase their overall personal performance by working on all the areas of a master card. In addition, the card groupings, games, review materials, practice materials, or creative activities can be grouped by series or grouped by expertise level. In other words, the performance and achievement material may be grouped in such a way that there are cross-platform, cross-level, or cross-discipline groupings.

FIG. 1B illustrates an example of a reverse side of the card used in the performance system and method. The reverse side of the card can include background graphics 107. Time or date increments 108 can be displayed including daily, weekly, or monthly increments during which a performance program will be followed. The card in FIG. 1B can also display a program or card title 109 along with the program or cards instructions. A plurality of shapes 111, slots, segments, or entries are used in a grid format and are used to check off achievement. The areas used to check off achievement can also be defined as performance event recording areas for record performance events or fulfillment events.

When a user tracks their performance with the performance chart, then the end user can become self aware about their life patterns in the context of the educational or performance areas being tracked. A date range, end date or expiration date 112 can be printed on the card representing the end of the performance tracking period or periods. In addition, company info or copyright info 113 can be printed on the card.

The grid area can be shaded using a plurality of grayscale or colored zones representing levels of achievement. For example, FIG. 1B illustrates three zones 114a, 114b, 114c. The first zone 114a can be shaded light grey. The second zone 114b can be shaded medium grey and the third zone can be shaded with dark grey. These differently shaded areas can represent, poor, better and best areas of the grid, thereby defining an optimum amount of achievement for each card. Of course, other achievement labels or grading may be applied to the zones. These shaded zones allow users to be able to assess their graded progress, and what they have been doing with a quick glance.

An alternative embodiment of the chart can be made to function as described above, but using instead a shape partitioned into segments, areas of a shape to be filled in, dots to connect, or other indicia that would how the user's performance increases.

FIGS. 2A and 2B illustrate an embodiment where card information is displayed horizontally on the front and back of a card with the approximate size and shape of a common credit card. This shape has rounded corners. In this embodiment, graphics can be printed as background 200 on the entire face of the card along with company info 201 (or 203) representing the card designer or manufacturer. An aperture 204 can be created in the card for attaching the card or cards to a device to secure them to a ring or lanyard.

Copyright info 204, a card or program title 205, performance program graphics 206, and a company name 207 can be printed on the cards. A defined area can be provided for the pluralities of shapes or areas 208 used to mark and keep track of performance progress. The performance or fulfillment indicia can run in a horizontal direction or in a vertical direction to track performance events. A vertical display of time increments 209 can be included such as days, hours, weeks, or months during which the motivation program will take place. The program or card title 210 can be printed onto the card as illustrated.

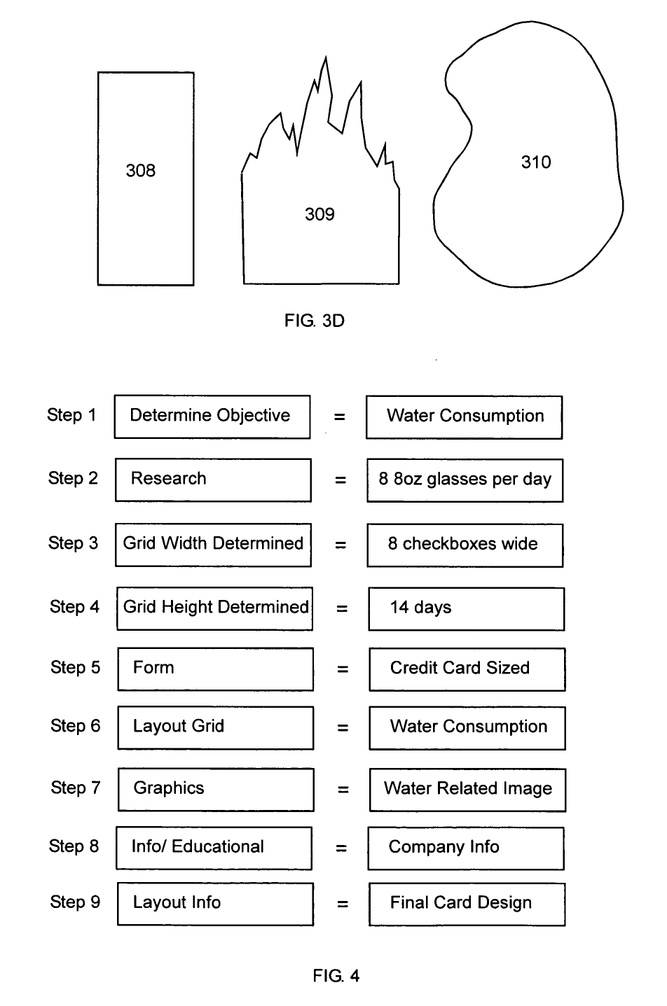

The shape of the card may vary depending of the motivational shape desired. For example, children may enjoy more character-oriented shapes. Alternatively, the shape may be picked based on the type of motivation goals for the program. FIG. 3A illustrates embodiments wherein some examples of the shape of the card could be a convex shape such as a circle 300, oval 301 or rectangle 302. FIG. 3B illustrates embodiments wherein some examples of the card shapes can be a profile or abstract shape such as a face profile 303 or leaf 304. FIG. 3C illustrates an embodiment wherein some examples of the shape of the card can be a concave shape such as a notched circle 305, star 306, or kidney bean shape 307.

FIG. 3D illustrates an embodiment wherein some examples of where the card shape can be larger, as illustrated in the rectangular 308, jagged 309, and larger kidney shaped cards. The use of different shapes and sizes of cards can promote card use and enable multiple formats or designs to enhance marketability. Using larger sizes can enable those who have visual challenges reading smaller print to more successfully use the cards. In accordance with another form of this embodiment, the cards and related systems can be made with alternative plastics, paper, metal, laminate or recyclable materials. The cards and related systems can also use bar codes, magnetic strips, or micro-printing to enable interaction with electronic devices.

The tracking shapes or areas can be organized in other patterns, as opposed to just grid shapes. Particularly, the shapes can be organized in starburst, circular, polygonal or other shapes. In addition, the shapes can be organized to follow the designs or silhouettes of the cards illustrated in FIGS. 3A-3D. Regardless of how the performance tracking shapes are organized, it is helpful for the end user to understand the tracking time period for each group of shapes (e.g., row, line) and the performance fulfillment associated with each shape.

The present invention aids individuals in enhancing their performance in specific areas of awareness, education, and assessment. End users of the performance improvements programs will attend educational and achievement meetings. After attending these meetings the cards will be used to provide further performance tracking, achievement, encouragement and incentives. By creating a chart on a card or cards, different areas of performance can be broken down and tracked and this enables gives a quick visual reference on progress. The end users performance can be tracked over time, and then assessed by users, management or trainers to measure performance and assess future needs. This is particularly valuable with respect to educational material because the educational performance and progress can be tracked over time as goals are fulfilled.

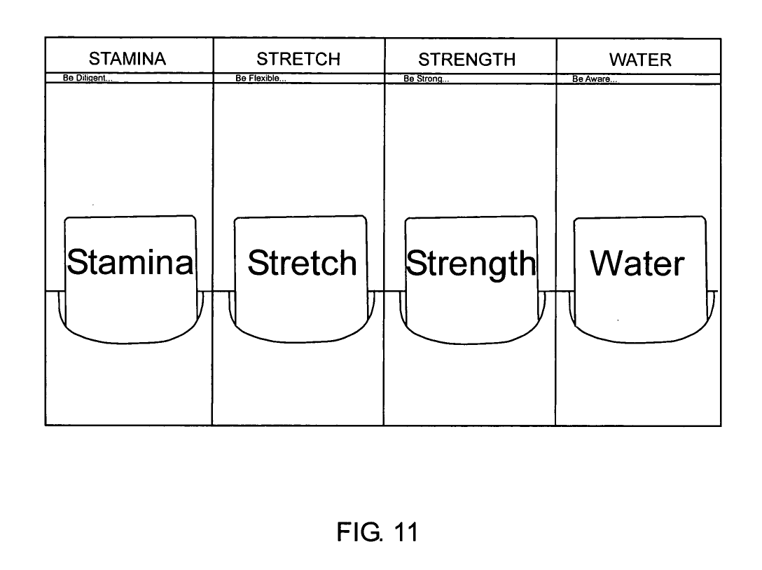

The cards can also be provided in a kit. The kit may include a brochure that folds out into a type of poster. Pouches can be formed in the brochure to hold the cards and the brochure can be folded to approximately the width of each separate card. The poster may also include motivational sayings, quotes, or informative text and graphics. Such a brochure is illustrated in FIG. 11.

Once the performance and fulfillment events or activities have been completed on the card, then the cards can be traded between end users or played in a game that is outlined with respect to the card topic or across several topics. These games may also be played between those achieving performance goals in separate topic areas as board and card games, or the games can be played using an electronic forum. The supervisor, mentor or teacher can also use the cards to play games with the end users. The cards may also be traded in for points that are redeemable for certain prizes or for company credit if the performance tracking is being done within a company. The cards can also be interlocking pieces that make up the playing surface of a board game or the interlocking pieces can be a vehicle for the gameplay.

An additional motivation award can be entering the cards into a receptacle at meetings or sending the cards into the company for a drawing or lottery type contest. The entry into the drawing signifies completing the performance tracking on card. In other words, the card is activated or valued when the tracking and achievement on the card is fulfilled, completed, or a certain amount of time has elapsed.

In addition, the end users who complete the education and performance cards or logs can receive other game oriented awards. For example, the end users can be awarded game pieces, board pieces, character pieces, strength units, special cards, etc. These game oriented awards can be items that are used for electronic games, computer games, and online activities that are incorporated into the performance method and programs.

Cards can also have pre-set elements that become active when the performance tracking elements are completed on the card. For example, values related to the type of card that has been completed may be included on the card. If the card is being used to teach music then the card may include values for studying music theory or for practice exercises.

In addition, random elements can also be included for the cards. Many games include an element of chance. So when the person using the card has achieved their performance goal they may be presented with a random fictional character, magic power, science fiction energy or similar information which is intentionally balanced against other random elements that may be obtained by other users who achieve the requirements of the cards. This allows the individuals who complete the card to play card games after they are completed. In addition, the random elements can make the cards collectible.

One aspect of the present invention is related to programs and products wherein the participants engage in the use of charts and educational material printed onto durable cards that help delineate and track choices or actions taken with regard to their health and fitness choices. For example, each participant may receive the cards through a subscription, membership or retail outlet and receive direction, support, recognition and incentives for achievements through community support, corporate or Internet-based community support. Thus, other aspects of the present invention are directed to methods for participating in programs using the cards and related programs for health and/or fitness. The cards can also be used as a program membership indicator in order to represent membership in the performance program and/or organization.

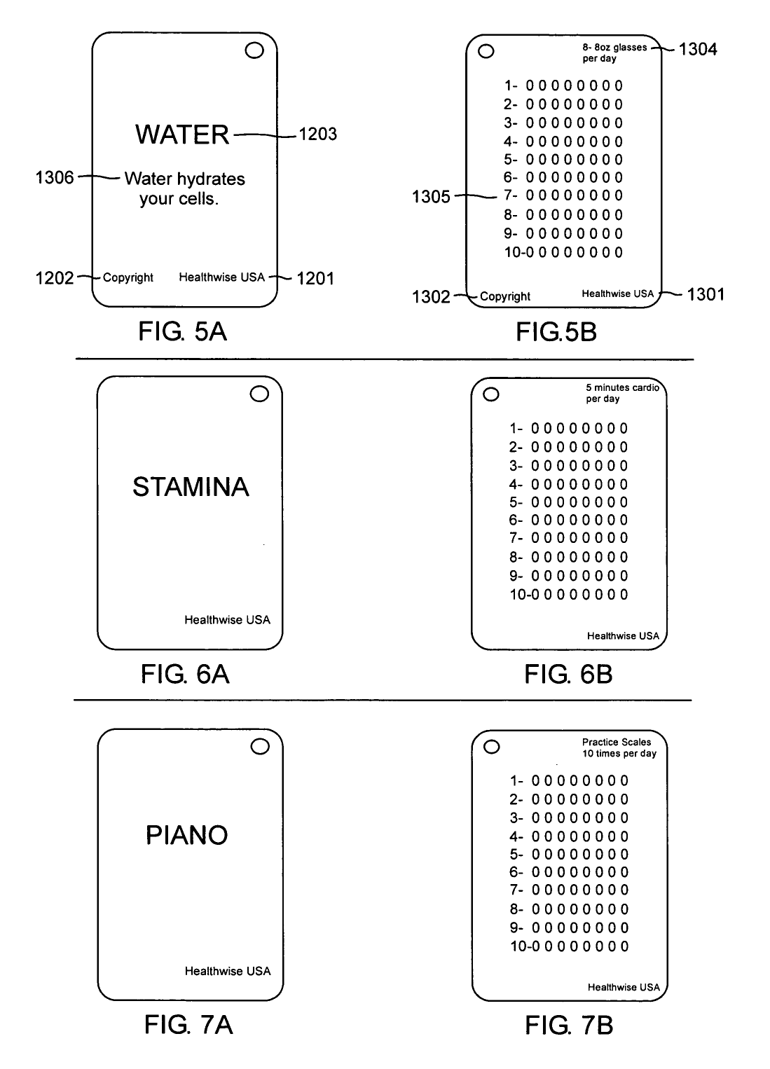

FIG. 4 illustrates a flow diagram used for designing the apparatus, methods and components of the present invention. In this case, water consumption will be used to illustrate an area of training and awareness. FIGS. 5-7 illustrate alternative examples of this embodiment.

Step 1. Area of training/awareness is determined. Water consumption for improved health purposes is used in this embodiment. In addition, other areas of training, education, and personal improvement awareness can also be identified.

Step 2. Area of awareness is researched. In this embodiment, it is medically recommended that an average person consume 8-8 oz. glasses per day.

Step 3. A grid row width or column height is designed to display increments of opportunity (unchecked boxes) vs. consumption or performance (checked boxes). In this embodiment rows of 8 check boxes have been selected to represent 8 oz. glasses of water. This way a user can have the total recommended amount of water, broken down into smaller more achievable increments. Alternatively, 4 or even 16 boxes can be used for this embodiment depending on the increment to be consumed by the user.

In one embodiment of the invention, grid indicia can be left open to correspond to user set qualifiers. For example, a user can set a physical goal of 5 pushups per time period thereby marking a column or row marker signifying completion of the “user determined” event. Thus, a very large grid can be provided and the user can determine at a performance meeting which goals they will assign to the boxes.

Step 4. A grid column height or width is determined by the date range or time period during which the motivational activity will take place. In this embodiment, 14 days is used as an example. A user can track their water consumption each day over a range of 14 days. Having this information close at hand on a card makes the motivation information accessible and easy to read. This accessibility and constant reminder helps motivate a user to consume a recommended amount of water and helps users become aware of situations that do not allow optimum consumption of water. This is because the record is kept over a given time period to help a user understand their own personal behavior patterns.

Step 5. Define size and shape (form) of apparatus. This example embodiment is configured as a standard “credit card” size shape and thickness. The size and shape can vary as discussed previously. Marketability elements, such as promotional characters, can also be designed into the card.

Step 6. Define best layout of grid. In this embodiment the grid is placed vertically on back of card (FIG. 5B).

Step 7. Define graphics. In this embodiment a modified wave can be placed on the front of the card (FIG. 5A) and the back of the card has a blank background or white back (FIG. 5B).

Step 8. Define the following general information to be printed on the apparatus. The apparatus or can include the company marketing info, company legal info, card use info, card use, expiration dates, and educational points of interest.

Step 9. Decide where to print general information on the apparatus. In this embodiment illustrated in FIGS. 5A and 5B the information can be placed as follows. The company name is printed in the lower right hand of the front and back of the card 1201, 1301. A copyright notice may be printed in the lower left hand of both front and back of the card 1202, 1302. Card use info can be printed on the upper right hand corner of the back of the card 1304. A card title is printed on front center of the card 1203. The grid 1305 can be configured and placed as 10 days tall by 8 checkboxes wide. Educational material or graphics can also be included as desired.

In another embodiment the grid layout may be reversed. For example, the grid may be organized so that the date ranges run left to right across the top, and check boxes run in vertical columns and represent performance vertically rather than horizontally.

An aspect of another embodiment of the present invention is a means of attachment, delivery, or presentation, such as lanyards, containers, wallets, key rings, belt clips, bracelets, clip on devices, and brochures.

The present invention can be applied to other areas of trackable performance such as: health, fitness, financial, job performance, family, management, budget, medical, schooling, and rehabilitation. This list is a partial list of areas where a large or time-consuming goal or objective can be outlined, and then broken down into smaller processes, steps, time, or effort increments. These larger objectives, with their respective broken down objectives can be used in the components of this invention.

There may be individuals who join the performance program, who already have some level of proficiency in a given area they are pursuing. In such cases, semi-proficient individuals can purchase card-pack levels matching their certain proficiency. For example, Bob plays piano for 3 years prior to becoming aware of the present performance program and games. He would qualify to purchase a certain card pack that would represent his skill level, and not be required to work from the start of the program.

The performance programs may also incorporate incentives for teachers, mentors, sponsors, or parents as specific performance goals or educational aims are met. In addition, a guide can be supplied with each kit for those who are supervising the program. The guide can be supplied online, as a paper pamphlet, as a brochure or tablet.

The apparatus provides specific functionality and benefits for an end user as defined below:
1. Awareness. The apparatus creates personal and educational awareness using educational graphics and info, press releases, research, etc.
2. Tracking A grid area is applied for tracking and improvement of performance.
3. Measurement. The present invention allows a user to track performance by checking off boxes.
4. Feedback A user can receive feedback from another source such as mentor, trainer, manager, supervisor, database, etc.
5. Interactivity. The apparatus creates interoperability and interactivity between users and their performance apparatus.
6. Portability. The apparatus can be card size, small brochure size, etc.
7. Incentives. The apparatus can have pre-set qualifiers that enable certain rights, rewards, or privileges.

In an alternative embodiment, the checkboxes or performance event recording areas can be demarcated by the following:
1. Scratch off areas.
2. Mechanically punched areas.
3. Pre-scored or perforated area to be easily knocked out.
4. Reactionary, color changing, and chemically or pressure sensitive areas.
5. Pull-tab or peel away stickers or perforations.
6. Stamp or impression device or marker.
7. Sticker or applied marker.
   The cards themselves can be embedded within larger “host” devices such as a brochure, a larger card, or a poster and then the card can be perforated and removed from the “host” card when it is needed. In addition, the performance recording areas can be used and recorded in a logbook or diary in one embodiment of the invention.

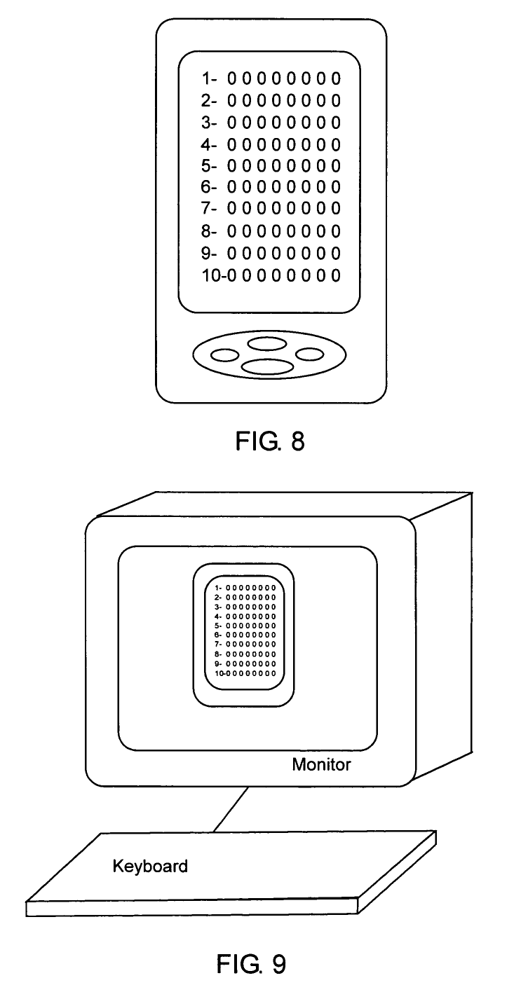

In FIG. 8, an alternative embodiment is illustrated on a hand held device. The components use in the performance cards can be replicated on the screen of the hand held device. Users can check boxes using a pointing stylus or other electronic input as performance is made and be able to recall their performance by visual reference.

In FIG. 9, an alternative embodiment is illustrated on a desktop computing device. The components of use in the performance cards can be replicated on the screen. Users may check boxes as performance is made and be able to recall them for visual reference. An advantageous aspect of this embodiment is the ability to store multiple chart cards, and potentially display multiple chart cards in an electronic format.

Another embodiment of the performance invention uses determined qualifiers for progressing end users through a graded series of programs and performance tracking levels. Example: Customer A is strongly encouraged to go through a beginner series of health program kits with cards, before he can utilize the advanced series of health program kits with the advanced series of cards.

In another embodiment, the performance chart signifies blocks of time such as a student might use for learning a musical instrument. The present invention can also use checkboxes for dividing a practice or learning time into segments. Accordingly, an hour practice period can be divided into subcomponents that contain specific practice activities. For example, subcomponents of the grid can represent blocks of time for an area of sports improvement, such as 15 minutes batting practice, 15 minutes long jump practice, etc. In another embodiment the grid can represent blocks of time for study. Such as 15 minutes for reading, 15 minutes for writing or 15 minutes observing.

In another embodiment, another variation of a learning cycle can be provided with the present invention. In one more generic embodiment of the segmented learning method, 15 minutes are set aside for learning, 30 minutes for practicing, and 15 minutes exploring a topic. Alternatively, 15 minutes can be used for communicating, 30 minutes for practicing, and 15 minutes for review. For example, if an end user is working toward mastering a computer application. Then 15 minutes can be applied to toolbar familiarity, 30 minute can be used for viewing a project/educational video, and the last 15 minutes can be used for studying a manual or reaching textbook familiarity.

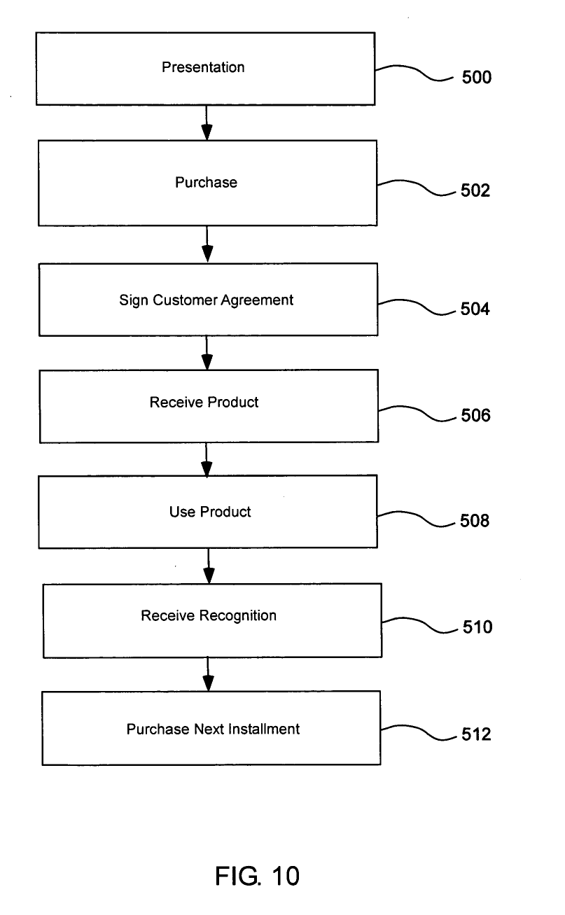

FIG. 10 is a flow chart illustrating a method of use for the present apparatus. An initial step is that an end user is presented with product and its associated service programs, as in block 500. The product may be presented to the consumer by an independent distributor, a course instructor, or another direct marketer.

A user can then determine which product and/or program that they desire to purchase as in block 502. For example, the consumer may want to participate in the “Walking Club” program, which includes participation in 1 monthly outing and receiving 1 consumable walking chart cards. Alternatively, the user can purchase the performance tracking products in groups of progressively graded motivation units. For example, a user may purchase an entire group of cards that includes 4-8 cards which each represent a step, phase, or segment of the program. Then the user can use a card from the pack of cards to track performance each week for one or more months. As an alternative to being grouped as packs, the cards may be grouped by segments, brochures, the type of reward that will be received, online access privileges, keyrings, etc.

A further step is that the end user signs legal/medical disclaimers as in block 504. In this step the consumer needs to sign a disclaimer protecting the company from medical liabilities since he/she may be participating in a physical activity, travel, or other activities.

The apparatus, card and associated program material can be sent to the end user via mail, email or downloaded and printed from a website as in block 506. In the present example, the user receives a walking club chart card, and information pamphlet or booklet.

The user can then consume product (i.e., uses cards) as outlined by program in block 508. In this stage, the user begins setting goals, and fills out a performance chart card as prescribed by the card and program outlines.

The user can receive recognition for pre-defined levels of performance as in block 510. In the example program, there can be a meeting once a month, coupled with a walking event, in which accomplishments are recognized and awarded. Awards may include special electronic bulletin board avatars, key ring cards, jewelry, graded program status or awards of defined nomenclature/program status (i.e.: novice, beginner, intermediate, advanced, expert). Patches, badges, medals, buttons and similar awards can also be provided when accomplishments and performance are recognized. In addition, the cards themselves can be a certificate of achievement in performance programs when segments, parts or level of the programs are completed.

The programs can be developed to enhance existing programs and businesses. Such as a direct marketing company selling a health drink. The direct marketing company can incorporate a series of health enhancement programs that would support the health improvement claims of their products.

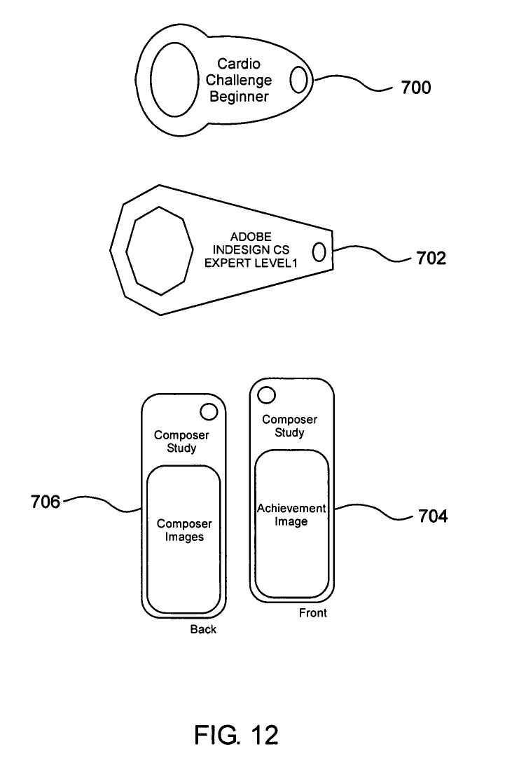

FIG. 12 illustrates that keycards 700-706 can be used as awards for accomplishments and completion of performance charts. In addition, special brochures, posters, and unique cards can be used as awards. The key ring card can also incorporate a performance chart or exclude the chart, while including active features for games, contests or online access to performance websites.

The key ring card can be used as a marketing device to new end users of the programs. Particularly, individuals will see the cards when the cards are given as awards to current program participants. In addition, key ring cards can act as a visual incentive and reminder of their accomplishments. The keycards can further be used to provide certain privileges to new clients who sign up for the performance program. For example, the user may receive a temporary benefit at a local fitness spa or bookstore.

Once the user has completed a level or graded motivation unit, then the user can pay for the next installment of a service/product as in block 512. Then the cycle can return back to block 506 and repeat.

In some situations, the installments of the performance product can be time based. For example, the program membership can receive performance games, cards, awards, brochures, and motivational materials that come out on a subscription basis every week, month or year. In addition, these time-based installments can include ongoing game, storylines, and performance challenges to create new storylines, art or music. Thus, the cards may be delivered to an end user as the story develops or performance challenges are presented.

In an alternative embodiment of the invention, the presentation step of FIG. 10 can use retail health outlets to present and market products and services. The following is a partial list of those retail health outlets where the present invention can be promoted: health food or vitamin stores, medical facilities, personal trainers, private clubs, physical therapy trainers/facilities, massage or alternative care facilities, chiropractors, or the Internet health websites.

Another marketing alternative is that other venues can be used for promoting the present invention as follows: TV, radio, Internet, seminars, direct mail, and newspapers. Further, the education and performance programs of the present invention can be promoted through educational facilities, schools, and government programs.

There are many different business formats available for distributing and promoting the present invention. One promotional method is to use a direct selling, independent distributor based organization to sell and distribute the products and services of the present invention. In this embodiment, independent distributors are used as an integral part of the business method to recruit not only clients and end users, but distributors as well. By combining performance awareness/enhancing apparatuses and services with the direct selling business vehicle, unique and valuable opportunities and incentives are created, not only for clients, but for distributors supporting the company's clients and end users as well.

In this embodiment, a direct selling network, or multi-level marketing business format is applied. The following steps are the general scope and means of this business method of performance.

Step 1. The product and any related supportive components, such as brochures, posters, pamphlets, program outlines, etc., are designed and/or manufactured.

Step 2. An incentive program is designed for Independent Distributor Network.

Step 3. Independent Distributors are then recruited.

Step 4. Independent Distributors are given support and training

Step 5. Independent Distributors build a clientele of retail customers.

Step 6. In conjunction with Step 5, Distributors recruit and train other Distributors.

Step 7. Distributors are compensated with retail profits.

Step 8. Distributors are compensated with down line commission overrides. (See definition below.)

Step 9. In conjunction with Step 8, management and leadership training are incorporated.

Step 10. In conjunction with the above, there would be alternative means of compensation such as car allowances, volume bonuses, coupons, certificates or paid vacations. There may also be leadership recognition and performance recognition that are provided to top promoters and producers.

Downline Commission overrides are defined in this method as compensation paid to a Distributor of a product where there is a multi-level or tiered retail sales incentive program. This encourages Distributors to recruit and train other Distributors who would be placed down line, or within a group of an Independent Distributor. For example, John (Dist. A) recruits Dave (Dist. B) and Mary (Dist. C). Dave and Mary would be in John's Downline. Concurrently, John would be in a position to receive financial incentives based on the sale of his down line group, consisting of himself, Dave, and Mary.

The goal and motivation aspect of the different embodiments of this invention can be applied to the following motivational categories: health, fitness, financial, job performance, family, management, budget, medical, and education.

In accordance with another aspect of this embodiment, the distribution of products and services of the present invention can be through different venues such as: retail shops, medical facilities, seminars, church groups, government, personal trainers, medical personnel, health clubs, schools, home schooling, game play venues, and the Internet.

In an alternative embodiment there are laminated cards that include a top piece with knockouts for viewing information. A bottom piece with graphics and info is printed strategically as to be viewed in the knockouts of the top piece. The bottom piece can also include moveable pieces in between, such as a sliding tab, or numerated wheels or other moveable parts. This enables a user to have a card with a tracking function, without the aid of another implement. The top layer and the bottom layer can be glued, welded or sealed together in such a manner as to allow an end user to move the parts to incrementally to track progress.

The motivational device and system of the present invention can also be applied in a business setting. The cards can be applied to business training elements. For example: A new employee may desire to become a master carpenter. These cards and their associated performance program can be used to allow the new employee to focus and direct his training. The employee needs to learn basic carpentry nomenclature, definitions, and fulfill basic “good employee” requirements. This information can be included in Program A, Level 1 and so on.

This educational material can be presented in a brochure/poster, and the card can track his job performance, skill proficiency, teamwork, communication skills, or even his hourly/daily profitability to the company. His requirements may be to show up on time, have a good attitude, work well with others, and then participate in after hours training or educational meetings. When the employee has completed the requirements on the card, and his boss or mentor signs off on that level, a pay raise, title, or bonus can be applied. Accordingly, the employee can be promoted from Apprentice level A to Apprentice level B as he progresses. This can apply to almost any business where there are graded levels of proficiency that need to be tracked and rewarded. In addition, implementing this system helps clarify the requirements for advancement.

This apparatus and method can also be applied where a certain employees, such as a secretary or business manager, need to get a higher level of expertise in an area. For example, an employee may need training in an area such as Microsoft® Excel, PowerPoint, or Word. A business can use these programs to motivate employees with defined incentives for reaching certain proficiency levels.

Another area where the present invention can be applied is in youth performance programs. These devices and methods can be used to develop a more up to date, and contemporary approach to develop outdoor skills, personal management, job exploration, conservation, practical knowledge, and group development.

Using the progressive programs, technologies, and incentives of the present invention, programs can be provided that step children and youth in and through the program, rather than having them count on outdated, unmotivated leadership and educational tools. A more user friendly management atmosphere is anticipated to occur as a result. These programs can enhance leadership training and opportunities. The present invention can be applied in a very exciting way to take advantage of not only these core ideas, but offer a much more complete, creative and up-to-date method to incorporate today's electronic technology in youth programs. The present system and method also have the advantage of being more versatile and can be applied with special programs that enhance certain aspects of performance that may be important or relevant to certain religious denominations, cultural backgrounds, or even family educational preferences.

An added benefit of the present apparatus is that these cards are durable and lightweight. The cards may contain first aid, survival, cooking info, or for the job exploration area, contain hot keys, definitions, or program tips. The cards can incorporate conservation data such as flora and fauna for observation and comparison techniques. Example: A “scout” program can have cards with native plants on them, and kids may be challenged to find the plant. Then the youth can pass-off certain knowledge about it such as, is it edible, could it be used as medicine, is it a native plant or introduced species?

It should be realized that the present invention can be applied to many educational, performance improvement, and commercial product areas. Accordingly, the present invention will implement performance programs in potential markets as their value to society becomes clear.

Unless the context clearly requires otherwise, throughout the description in the following examples, the words comprise, comprising, and the like are to be construed in an inclusive sense as opposed to an exclusive or exhaustive sense; that is to say in the sense of “including, but not limited to.” Words using the singular or plural number also include the plural or singular number, respectively. Additionally, the words “herein,” “above,” and “below” and words of similar import, when used in this application, shall refer to this application as a whole and not to any particular portions of this application.

The description of embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. For example, while certain features are presented above in a given order, alternative embodiments may include such features in a different relationship than that described above. For example, although one or more of the foregoing embodiments may illustrate a card that tracks performance of activities or achievements related to health, in other embodiments, the cards can track other activities or achievements. The teachings of the invention provided herein can be applied to other products, not only the cards described herein. The various embodiments described herein can be combined to provide further embodiments. Further, aspects of the invention can be modified, if necessary, to employ the features described above in yet further embodiments. These and other changes can be made in the invention in light of the above detailed description.

It is to be understood that the above-referenced arrangements are illustrative of the application for the principles of the present invention. It will be apparent to those of ordinary skill in the art that numerous modifications can be made without departing from the principles and concepts of the invention as set forth in the claims.

1. A method for educating individuals and incorporating educational principles into a person's activities using performance measurements, comprising the steps of:
delivering educational materials to a person regarding at least one topic selected by the person;
agreeing with the person to carry out a performance program to learn the educational materials by implementing activities and incentive structure related to the educational materials;
supplying a performance measurement device containing incremental fulfillment recording areas which divide the activities for learning the educational materials into pre-structured time segments over an implementation period;
structuring community support with the person in relation implementation period to measure the amount of fulfillment of the performance measurement device; and
rewarding the person based on an amount of fulfillment of the activities implemented.

2. A method as in claim 1, wherein the step of supplying a performance measurement device, further comprises the step of supplying a performance measurement chart.

3. A method as in claim 1, wherein the step of rewarding the person further comprises the step of rewarding the person with additional educational materials.

4. A device for performance tracking and improvement, comprising:
a durable card configured to be carried by an end user;
a performance chart located on the durable card;
a plurality of performance event recording areas in the performance chart, the performance event recording areas being configured to correspond to the time period, frequency, and quality of performance events performed by an end user in a fulfillment commitment made by the end user.

5. A device as in claim 4, further comprising a plurality of cards wherein each of the plurality of cards represent a separate level of a progressive program for performance tracking.

6. A device as in claim 5, wherein the separate levels of the progressive program represent levels selected from the group consisting of time passed, events fulfilled, and proficiency gained.

7. A device as in claim 4, wherein a durable card for a next performance level cannot be obtained by the end user until a previous level of a performance program has been completed.

8. A device as in claim 4, wherein a durable card for a next performance level cannot be obtained by the end user until a pre-determined amount of time has passed.

9. A device as in claim 4, further comprising graphical images on the durable card selected from the group consisting of scenery, event graphics, promotional images, biographies, and educational images.

10. A device as in claim 4, further comprising a pre-defined location on the durable card for mechanically altering performance event recording areas after performance events have been recorded in the performance chart.

11. A device as in claim 4, further comprising a pre-defined location on the durable card for placing an award after the performance events have been recorded in the performance chart.

12. A device as in claim 11, further comprising an award selected from the group consisting of stickers, decorations, ornaments, and appliqué, the award being configured to be applied on the durable card in the pre-defined location after a plurality of performance events have been recorded on the performance chart.

13. A device as in claim 11, further comprising an award sticker applied on the durable card that represents a pre-defined status for the durable card.

14. A device as in claim 11, further comprising a graded value award sticker based on effort applied in completing performance events on the durable card, wherein the graded status for the durable card is configured to play a game with other end users in a motivational program.

15. A device as in claim 14, further comprising a graded value award sticker from the group consisting of a power level, a strength level, a character, skill theme, and a point value.

16. A device as in claim 14, further comprising graded awards from the group consisting of stickers, ornaments, emblems or decorations, wherein the graded awards are used to signify talents, attributes, or elements in game play.

17. A device as in claim 14, further comprising graded stickers used to signify creative activities.

18. A device as in claim 4, further comprising a card deck of the durable cards that can be purchased based on a skill level of an individual entering a performance program, wherein a graded status for the card deck can be used to play games with other end users in a performance program.

19. A device as in claim 4, further comprising a graded value award based on effort applied in completing performance events on the durable card which represents a graded status for the durable card that can be used to play a game.

20. A device as in claim 4, wherein the performance events on the durable card represent performance events selected from the group consisting of health, fitness, musical training, financial organization, job performance, business management, budgeting, medical rehabilitation, and education.

21. A device as in claim 4, wherein the performance events can represent multiple segments of a performance event.

22. A device as in claim 21, wherein the multiple segments of the performance events are divisions of a one hour performance event, including a first 15 minutes of a performance event, a second 30 minutes of a performance event and a third 15 minutes of a performance event.

23. A device as in claim 4, wherein the performance event recording areas are arranged in a grid.

24. A device as in claim 4, wherein the performance event recording areas can be ordered in a vertical or a horizontal direction.

25. A device as in claim 4, wherein the performance event recording areas in the performance chart are divided according to time divisions selected from the group consisting of days, weeks, and months.

26. A device as in claim 4, wherein shaded or colored zones are included in the performance chart to represent levels of achievement attained.

27. A device as in claim 4, further comprising a random graded element that can be added to the card, wherein the random graded element can be used to play a game.

28. A device as in claim 4, wherein the performance events can be recorded in the performance chart using a method selected from the group consisting of scratch off areas, mechanically punched areas, pre-scored areas, perforated areas, color changing areas, chemically sensitive areas, pressure sensitive areas, pull-tabs, peel away stickers, perforations, stamping, an impression device, an impression marker, a sticker, and applying marker.

29. A device as in claim 4, wherein the durable card is made material selected from the group consisting of plastic, plastic coated paper, metal, paper, and an electronically readable material.

30. A device as in claim 4, wherein the durable card is included with an educational brochure.

31. A device as in claim 4, wherein the cards are interlocking pieces that make up the playing surface of a board game.

32. A method for marketing a performance improvement product to an end user, comprising the steps of:
presenting the end user with a plurality of performance products having progressively graded performance units;
selecting a performance product which the end user wants to purchase;
delivering the performance product to the end user;
using the performance product in order to encourage the end user to modify a desired behavior, wherein the use of the performance product is performed by the end user to track behavior habits;
recognizing the end user for the prescribed use of the performance product; and
purchasing additional installments of the performance product which are selected from the progressively graded performance units.

33. A method as in claim 32, further comprising the step of requiring the end user to complete a previous installment of the performance product before allowing the end user to purchase an additional installment of the performance product.

34. A method as in claim 32, further comprising the step of presenting the user with a plurality of performance products selected from the group consisting of health, fitness, musical training, financial organization, job performance, business management, employee training, budgeting, medical rehabilitation, game play, and education.

35. A method as in claim 32, further comprising the step of selling the performance product to the end user using a marketing method selected from the group consisting of a direct selling network, a consumer direct marketing method, a multi-level marketing network, a party plan and network marketing.

36. A method as in claim 32, further comprising the step of selling the performance product to the end user using a selling method selected from the group consisting of electronic commerce sales, website sales, retail outlets, television sales, radio sales, seminars, and direct mail.

37. A method as in claim 32, further comprising the step of providing progressively graded performance units directed toward education or performance tracking.

38. A method as in claim 32, further comprising the step of providing progressively graded performance units that are cards.

39. A method as in claim 32, wherein the cards can be traded and played in a game and the end user can be awarded game pieces.

40. A method as in claim 38, further comprising the step of trading in the cards for points.

41. A method as in claim 38, further comprising the step of trading in the cards for company credit.

42. A method as in claim 38, further comprising the step of providing a brochure configured to hold the cards and display performance information.

43. A method as in claim 38, further comprising the step of allowing the cards to be used in a lottery type contest after the performance unit on the cards has been completed.

44. A method as in claim 32, further comprising the step of signing an installment agreement for the performance product to be purchased by the end user.

45. A method as in claim 32, further comprising the step of purchasing the performance products in groups of progressively graded performance units.

46. A method as in claim 32, wherein the step of delivering the performance product to the end user further comprises the step of sending a customized performance product to the end user via mail.

47. A method as in claim 32, wherein the step of recognizing the end user further comprises the step of recognizing the end user with an award.

48. A method as in claim 32, wherein the step of recognizing the end user further comprises the step of rewarding the end user with a key ring card, jewelry, or electronic avatars on a web site.

49. A method as in claim 32, wherein the step of recognizing the end user further comprises the step of rewarding the end user with a reward for an electronic game or board game selected from the group consisting of power points, icons, characters, or character values

50. A method as in claim 32, wherein the step of recognizing the end user further comprises the step of rewarding the end user with a graded program status.

51. A method as in claim 32, wherein the step of recognizing the end user further comprising the step of recognizing the user with an award.

52. A method as in claim 32, further comprising the step of supplying the user with a service program and including recognition meetings for prescribed use of the performance products.

53. A method as in claim 32, further comprising the step of using the performance product in order to encourage the end user to modify a desired behavior, further comprises the step of encouraging the end user learn a new skill, gain knowledge, or gain expertise.

54. A electronic performance device, comprising:
an electronic computing device configured to be carried by an end user;
a display screen coupled to the electronic computing device;
a performance chart configured to be displayed on the display screen of the performance device;
a plurality of performance event display segments in the performance chart, the performance event display segments being configured to correspond to the time period and frequency of the performance program committed to by the end user; and
a plurality of input buttons configured for entering information into the performance event display segments of the performance chart.

55. An electronic performance device as in claim 54, further comprising a smart card that can be coupled to the electronic computing device in order to upload information regarding the occurrence of events that can be stored in the performance chart.

56. An electronic performance device as in claim 55, wherein the smart card further comprises,
a user entry button configured to be activated by the end user when a performance event has taken place;
a memory for storing a performance event that was entered by the end user and a date and time the performance event was entered.
